(19) United States
(12) Patent Application Publication
(10) Pub. No.: US 2022/0099214 A1
(43) Pub. Date: Mar. 31, 2022

(54) Long Hole Drill Assembly With Power Cut-Off

(71) Applicant: Shawn PEEVER, Iroquois Falls (CA)

(72) Inventor: Shawn PEEVER, Iroquois Falls (CA)

(21) Appl. No.: 17/037,793

(22) Filed: Sep. 30, 2020

(51) Int. Cl. F16K 31/08

(52) U.S. Cl. CPC F16K 31/088; B25F 5/001

(57) ABSTRACT

A safety barrier assembly for use with pneumatically and/or hydraulically powered tool, includes an elongated strap barrier connected to an actuator block. The actuator block is adapted for releasable connection to a valve housing through which the tool driving fluid flow passes. Decoupling of the actuator block from the valve housing effects the repositioning of fluid control valves to prevent continued driving fluid flow to the tool.

### SCOPE OF THE INVENTION

The present invention relates to a safety barrier assembly, and more particularly to a power cut-off safety barrier assembly which when breached, is adapted to interrupt a power fluid flow to a pneumatically or hydraulically driven tool, and more preferably a pneumatically operable drilling tools.

### BACKGROUND OF THE INVENTION

In underground mining operations, pneumatically driven long hole drilling tools or drill rigs are commonly employed.

These drill rigs are most commonly operated from a swing arm mounted valve bank control unit. These controls put operators in close proximity to the rotating steel rods which can lead to possible entanglement injuries.

Operators must add and remove drill rods in the process of drilling a hole, and may also accidentally enter the dangerous zone. Without a zero energy state in the rotation circuit, entanglement is always a concern. Because there is normally no electricity available at the drill locations, commonly used methods of automatic energy isolation are not possible.

### SUMMARY OF THE INVENTION

The present invention seeks to provide a safety barrier as part of power cut-off assembly for power driven equipment. The power cut-off assembly is configured to interrupt a flow of hydraulic and/or pneumatic fluid used to provide power, in the event a user may intentionally or inadvertently contact or otherwise attempt to move past the barrier.

More preferably, the power cut-off assembly is non-electrically actuable to interrupt the tool driving pneumatic or hydraulic fluid flow.

In one possible embodiment, the safety barrier may be provided as rigid, semi-rigid or a flexible barrier which may be extended or otherwise positioned to physically prevent or restrict movement of the operator therepast into cordoned-off or selected areas deemed possibly hazardous.

More preferably, the power cut-off assembly is provided for use with hydraulically and/or pneumatically powered mining equipment, such as rock drills and boring tools. The cut-off assembly includes one or more fluid flow control valves which are activatable to interrupt the flow of tool driving hydraulic and/or pneumatic fluid on contacting the safety barrier with a predetermined threshold force. In a most preferred construction, the fluid flow valves are magnetically activatable however mechanically activated valves may also be used.

The safety barrier may be provided with a suitable control valve actuator selected to effect actuation of one or more of the fluid flow control valves when the predetermined threshold force is applied. Most preferably, the predetermined threshold force is selected at between about 0.5 N and about 25 N, and preferably between about 1 N and 5 N.

The safety barrier preferably is provided as a flexible rope, web or strap, and has a length selected at between about 0.5 and 10 meters however, longer or shorter barriers may also be used. Flexible barriers may include without restriction, flexible straps, ropes and/or chains, as well as plastic or woven mesh panels or screens. Where longer flexible barriers are provided, the cut-off assembly preferably includes a tensioner selected to maintain an extended length of the barrier under a tensile force, selected less than the predetermined threshold force. Suitable tensioners include without restriction, bungees, springs, manual and automatically actuated coilers and spools, and strap winders and ratchets.

According to various non-limiting embodiments, the present invention resides in various different aspects, and which include without limitation at least the following:

1. A pneumatic power cut-off assembly for use with a pneumatically operable tool, the cut-off assembly including a valve housing for fluidic connection to a pneumatic air supply of the tool to selectively interrupt a driving flow of air thereto, a releasable actuator provided for selective attachment to and detachment from the valve housing, and barrier element coupled to the releasable actuator, the valve housing comprising, a coupling surface for mated engagement with a mating surface of the releasable actuator, an axially extending bore being formed in said coupling surface, a pneumatic fluid flow path extending at least partially through the housing from an inlet end to an outlet end, and a valve chamber formed in said housing and having a chamber inlet fluidically communicating with the inlet end, a chamber outlet fluidically communicating with the outlet end, and a valve seat, a valve assembly comprising a movable piston having a sealing member selectively positionable by the movement of the piston, and a biasing member, the sealing member disposed in said valve chamber and selectively positionable between a sealing position, where said sealing member engages said valve seat to substantially restrict a flow of air between said chamber inlet to said chamber outlet, and a flow position, where said sealing member is moved away from said valve seat to permit the flow of air from said chamber inlet to said chamber outlet, the piston including a ferromagnetic stem portion, axially movable relative to said bore between a retracted position, where said end portion is moved outwardly relative to said coupling face and the sealing member is in said flow position, and an extended position, where said end portion is moved inwardly relative to said coupling face and the sealing member is moved to the sealing position, the biasing member resiliently biasing the piston towards the extended position, wherein, the releasable actuator includes a magnet, the magnet being selected whereby when the mating surface is provided in mated engagement with the coupling surface, the magnet providing a force of attraction with said stem portion sufficient to axially reposition the piston to the retracted position against the bias of biasing member.
2. A hydraulic pneumatic tool cut-off safety assembly for interrupting a flow of hydraulic pneumatic fluid from a fluid source to a hydraulic pneumatically driven tool, the cut-off assembly comprising, a valve housing comprising, a valve chamber defining a flow path therein extending from a chamber inlet, adapted for fluidic communication with an upstream supply line for receiving the driving flow of pneumatic fluid from said fluid source, to a chamber outlet adapted for fluidic communication with a downstream supply line for providing said driving flow of pneumatic fluid to said pneumatic tool, and a valve seat disposed along said flow path, a valve assembly comprising, a piston having a ferromagnetic portion and sealing surface configured for substantially mated engagement with the valve seat, the piston being disposed for movement relative to said valve chamber between a flow position, wherein said sealing surface is spaced from said valve seat to permit a driving flow of pneumatic fluid from said chamber inlet through said chamber outlet and to said tool, and a sealing position, wherein said sealing surface is moved into sealing contact with said valve seat to substantially prevent the flow of said pneumatic fluid therepast, a biasing member being selected to resiliently bias the piston towards the sealing position, and an actuator assembly comprising, a magnet assembly detachably mountable in a coupled position with said valve housing, the magnet assembly including at least one magnet selected whereby when said magnet assembly is in said coupled position, a magnetic force attraction between said at least one magnet and said ferromagnetic portion effects the repositioning of said piston relative to the valve chamber to the flow position against the resilient bias of the biasing member, and a release member coupled to the magnet assembly and selected to facilitate the decoupling of the magnet assembly from the valve assembly upon the application of a minimum threshold force thereto to effect the return movement of the piston to the sealing position by the bias of the biasing member, the release member being selected from the group consisting of a handle, a strap, a rigid or semi rigid barricade, a flexible barrier, a gripping member, a tab, a mesh panel, and a flexible tether.
3. A pneumatic long hole drill assembly comprising a reciprocally movable pneumatic drilling tool adapted to receive a flow pneumatic fluid from a pneumatic fluid source, and a pneumatic flow cut-off assembly for interrupting the flow of pneumatic fluid between said fluid source to said drilling tool on the occurrence of an unsafe operator condition, the drilling tool comprising a rotatory drive, a pneumatic fluid flow circuit selected to provide fluidic communication between said rotary tool and said pneumatic fluid source and comprising first and second flow passages, and a pneumatic control manifold for regulating the flow of pneumatic fluid in the pneumatic fluid flow circuit, the pneumatic control manifold including, a fluid inlet for fluidically communicating with the pneumatic fluid source, a first fluid flow outlet fluidically communicating with said first flow passage to provide a first driving flow of pneumatic fluid therealong in a first driving flow direction to effect rotation of said rotary drive in a first direction, a second fluid flow outlet fluidically communicating with said second flow passage to provide a second driving flow of pneumatic fluid therealong in a second driving flow direction opposite to said first driving flow direction to effect rotation of said rotary drive in a second opposite direction, and a control valve for selectively directing the flow of pneumatic fluid outwardly from said first flow outlet or said second flow outlet, the cut-off assembly including, a valve housing comprising respective valve chambers associated with each of said first and second flow passages, each valve chamber defining a respective flow path therethrough extending from a chamber inlet to a chamber outlet, the chamber inlet and chamber outlet each being in fluidic communication with respective upstream and downstream portions of the associated said first and second flow passage, and a valve seat disposed along said flow path, a valve assembly comprising, a piston disposed in an associated one of the valve chambers, each piston having a ferromagnetic portion and sealing element configured for substantially mated engagement with the valve seat, the piston being disposed for movement relative to said associated valve chamber between a flow position, wherein said sealing element is spaced from said valve seat to permit the associated driving flow of pneumatic fluid from said chamber inlet to said chamber outlet, and a sealing position, wherein said sealing element is moved into sealing contact with said valve seat to substantially prevent associated driving the flow of pneumatic fluid therepast, a spring member associated with each piston and being selected to resiliently bias the piston towards the sealing position, and an actuator assembly comprising, a magnet assembly detachably mountable in a coupled position with said valve housing, the magnet assembly including a magnet associated with each piston, each magnet being selected whereby in the absence of the associated driving flow of pneumatic fluid when said magnet assembly is in said coupled position, a magnetic force attraction between each magnet and the ferromagnetic portion of each associated piston maintains and/or effects the repositioning of said piston relative to the associated valve chamber to the flow position against the resilient bias of the spring member, and a release member or other barrier element or member being coupled to the magnet assembly and selected to facilitate the decoupling of the magnet assembly from the valve assembly upon the application of a minimum threshold force thereto.
4. The assembly according to any preceding and/or hereafter described aspects, wherein said magnet comprises a rare earth magnet disposed in said mating surface and/or coupled relative to the releasable actuating or safety barrier.
5. The assembly according to any preceding and/or hereafter described aspects, wherein said barrier element comprises a flexible strap portion having a longitudinal length selected at between about 1 metre and 10 metres, preferably about 2 to 7.5 meters, and/or said cut-off assembly further including a tensioner for maintaining the flexible strap portion under tension with a barrier element tension face, said magnet is selected whereby said force of attraction is selected to maintain mated engagement of said mating surface and said coupling surface under the barrier element tension force selected less than a predetermined threshold force.
6. The assembly according to any preceding and/or hereafter described aspects, wherein said tool comprises a long hole rock drill, said coupling surface and said mating surface each comprising generally planar surface portions configured for mated juxtaposition.
7. The assembly according to any preceding and/or hereafter described aspects, wherein said sealing member comprises a flexible diaphragm.
8. The assembly according to any preceding and/or hereafter described aspects, wherein said sealing member comprises a resiliently flexible double diaphragm, and whereby on movement to said sealing position, a partial pressurization of said valve chamber by the driving flow of air from said inlet end into said chamber inlet prevents return movement of the piston to the retracted position.
9. The assembly according to any preceding and/or hereafter described aspects, wherein the biasing member comprises a resiliently compressible electronic member or spring, and wherein the predetermined threshold force is selected at between about 0.5 and 15 N, and preferably between about 1 to 5 N.
10. The assembly according to any preceding and/or hereafter described aspects, wherein the barrier element is selected from the group consisting of a tab, a flexible tether, a flexible mesh panel, and a substantially rigid barricade.
11. The assembly according to any preceding and/or hereafter described aspects, wherein the sealing member comprises a resiliently deformable diaphragm, further wherein the inlet end fluidically communicates with an upstream portion of a supply line for receiving said supply of driving air, and respectively, at each of the inlet and outlet ends, the outlet end fluidically communicates with a downstream portion of said supply line for supplying said driving air to said tool.
12. The assembly according to any preceding and/or hereafter described aspects, further comprising a reverse-flow bypass assembly, the bypass assembly configured to permit a reverse flow of air or fluid in a direction opposite to the driving flow and including, a bypass conduit providing direct fluidic communication between the upstream supply line and the downstream supply line, and a one-way valve selected to permit airflow along said bypass conduit only from said downstream supply line to said upstream supply line.
13. The assembly according to any preceding and/or hereafter described aspects, wherein the release member has a longitudinal length selected at between about 0.5 and 7.5 metres, preferably 1 and 3 metres, and/or said minimum threshold force is selected at between about 0.5 and 10 N, preferably between about 1 and 5 N.
14. The assembly according to any preceding and/or hereafter described aspects, wherein said valve chamber comprises an upstream portion on a first side of said valve seat spaced toward said chamber inlet, and a downstream portion on a second other side portion of said valve seat spaced towards said chamber outlet, and wherein a movement of the piston to the sealing position, partial pressurization of the upstream portion by the driving flow of pneumatic fluid prevents movement of the piston to the flow position by the magnetic force attraction.
15. The assembly according to any preceding and/or hereafter described aspects, further comprising a reverse-flow bypass assembly, the bypass assembly configured to permit a reverse flow of air in a direction opposite to the driving flow and including, a bypass conduit providing direct fluidic communication between the upstream supply line and the downstream supply line, and a one-way valve selected to permit airflow along said bypass conduit only from said downstream supply line to said upstream supply line.
16. The assembly according to any preceding and/or hereafter described aspects, wherein said tool comprises a long hole rock drill, wherein said barrier element comprises a flexible strap portion having a longitudinal length selected at between about 1 metre and 10 metres, and/or said cut-off assembly further including a tensioner for maintaining the flexible strap portion under tension with a barrier element tension face, said magnet is selected whereby said force of attraction is selected to maintain mated engagement of said magnet or mating surface and said coupling surface under the barrier element tension force selected less than a predetermined threshold force.
17. The assembly according to any preceding and/or hereafter described aspects, wherein when each said piston is disposed in said flow position, the sealing element of each piston being moved towards an upstream portion of said associated valve chamber, and on detachment of said magnet assembly, the associated driving flow of pneumatic fluid along the first flow passage or second flow passage in the respective first or second driving flow direction, partially pressurizing the upstream portion of associated valve chamber to prevent movement of the associated piston to the flow position by the magnetic force attraction.
18. The assembly according to any preceding and/or hereafter described aspects, wherein the first flow passage further includes a first reverse flow bypass conduit for providing fluid communication between the upstream portion of the first flow passage and the downstream portion of said first flow passage, a check valve disposed in said first reverse flow bypass conduit, the check valve being selected to permit only a reverse flow of pneumatic fluid from said rotatory drive to said pneumatic control manifold when said second driving flow of pneumatic fluid flow is supplied in said second driving flow direction.
19. The assembly according to any preceding and/or hereafter described aspects, wherein the second flow passage further includes second reverse flow bypass conduit providing fluid communication between the upstream portion of said second flow passage upstream from the associated valve chamber and a downstream portion of said second flow passage downstream from the associated valve chamber a check valve disposed in said second reverse flow bypass conduit, the check valve being selected to permit only a reverse flow of pneumatic fluid from said rotatory drive to said pneumatic control manifold when said pneumatic fluid flow is supplied in said first driving flow direction.
20. The assembly according to any preceding and/or hereafter described aspects, wherein the release member is selected from the group consisting of a handle, a strap, a rigid or semi rigid barricade, a flexible barrier, a gripping member, a tab, a mesh panel, and a flexible tether.
21. The assembly in accordance with any of the preceding aspects for use with a hydraulically operable tool, and wherein a hydraulically fluid flow is provided in substitution for the pneumatic air flow.

### BRIEF DESCRIPTION OF THE DRAWINGS

Reference may now be had to the following detailed description taken together with the accompanying drawings in which:

FIG. 1 shows schematically, an underground long bore drilling rig having a rotary drilling tool and power cut-off assembly in accordance with a preferred embodiment of the invention;

FIG. 2 shows the power cut-off assembly shown in FIG. 1, with a detachable barrier actuator assembly in a coupled position mounted to the assembly valve housing in operation of the tool;

FIG. 3 shows schematically the detachable barrier actuator decoupled from the assembly valve housing on the application of the predetermined threshold force thereon;

FIG. 4 shows a schematic partial view of the power cut-off assembly shown in FIG. 1;

FIG. 5 illustrates schematically the movement of a driving flow of pneumatic fluid through the assembly valve housing in operation of the rotary drilling tool in a first driving direction;

FIG. 6 shows a partial cross-sectional view of the valve housing, showing the positioning of a valve assembly therein in a retracted position to permit flow of pneumatic driving fluid therethrough;

FIG. 7 illustrates schematically the interruption of the driving flow of pneumatic fluid through the valve body, following detachment of the barrier actuator assembly from the assembly valve housing; and

FIG. 8 shows a partial cross-sectional view of the valve assembly shown in FIG. 6, showing the positioning of the valve assembly in an extended position to interrupt driving fluid flow therethrough.

### DETAILED DESCRIPTION OF THE PREFERRED EMBODIMENTS

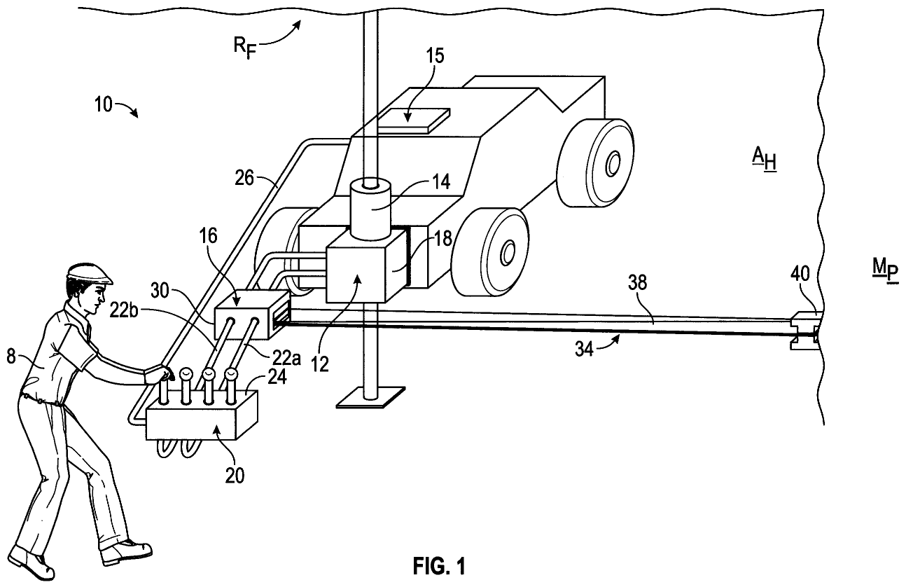

Reference may be had to FIG. 1 which illustrates an underground mining drilling rig 10 in accordance with a preferred embodiment of the invention. The drilling rig 10 is, most commonly, wheel mounted, and includes a pneumatically operated long hole drill assembly 12 having a rotary drilling tool 14, a pneumatic air supply 15, and a power cut-off assembly 16. As will be described, the power cut-off assembly 16 is provided as a safety system and is adapted to interrupt a power air flow from the air supply 15 to the drilling tool 14 in the event of unsafe operator movement.

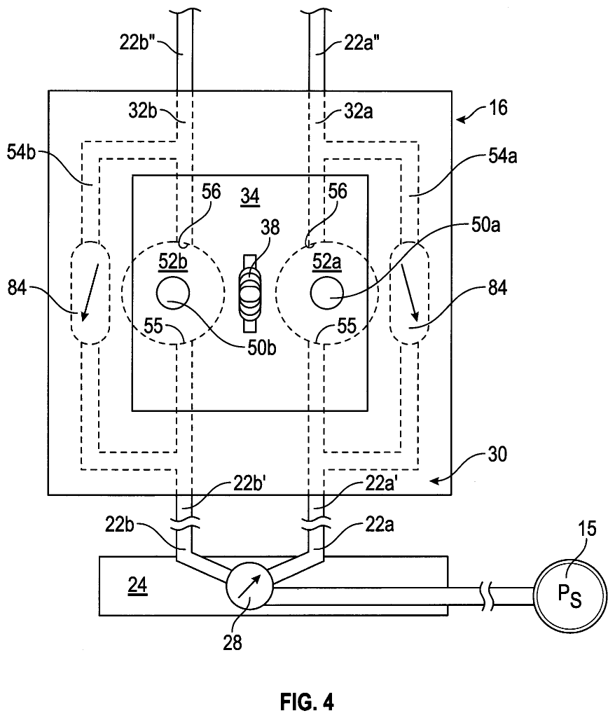

The drilling tool 14 includes a pneumatically driven motor 18 which is operated by a mechanical valve bank unit 20, and which is selectively driven in reciprocal rotary movement by driving air flow which is supplied by way of pneumatic fluid flow lines 22a, 22b. The valve bank control unit 20 fluidically communicates with the air supply 15 via a supply line 26 and includes a non-electrically operated pneumatic control manifold 24 which incorporates valving 28 (FIG. 4) operable to selectively direct air flow through. The control unit 20 is mounted to allow an operator 8 to operate the drill rig 10 from a distance spaced back from the drilling tool 14 and active rock face (R_{F}). The control manifold 24 is provided in fluid communication with the pneumatic air supply 15, and is operable to effect activation of the valving 28 to direct tool-driving air flow selectively along the flow lines 22a or 22b, to effect rotation of the motor 18 in forward and reverse directions. As will be described, the power cut-off assembly 16 is positionable to ensure that the user 8 operates the mining drill rig 10 spaced away from more hazardous areas A_{H}, adjacent from the active rock face R_{F} and drilling tool 14, providing enhanced user safety from rock bursts and possible drill tool entanglement.

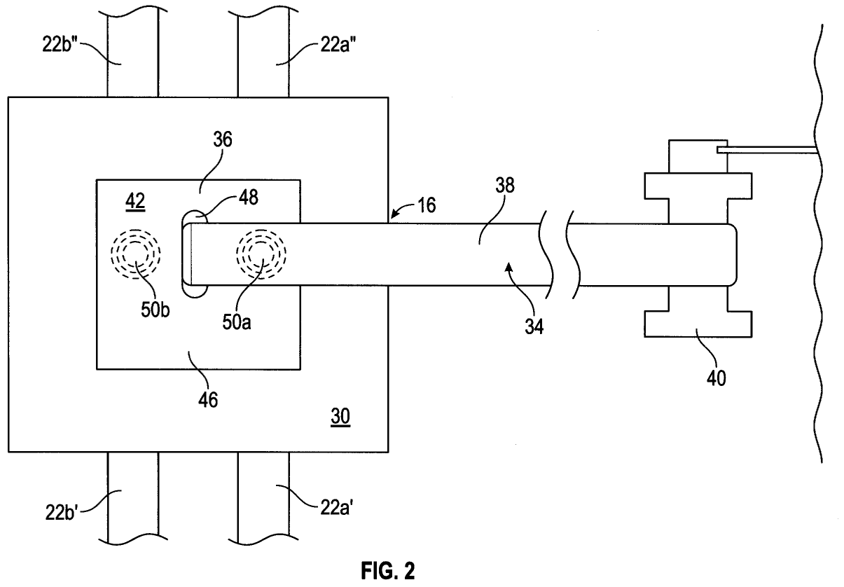

FIGS. 2 to 4 illustrate best the power cut-off assembly 16 in accordance with a preferred embodiment. The cut-off assembly 16 includes a plastic valve housing 30, which includes a pair of pneumatic fluid flow paths 32a, 32b, and a barrier actuator assembly 34. Each flow path 32a, 32b is in fluidic communication with a respective pneumatic fluid flow line 22a, 22b. As will be described, the barrier actuator assembly 34 is adapted for a selective attachment to and detachment from the valve housing 30 to permit or prevent the flow of pneumatic driving fluid therethrough.

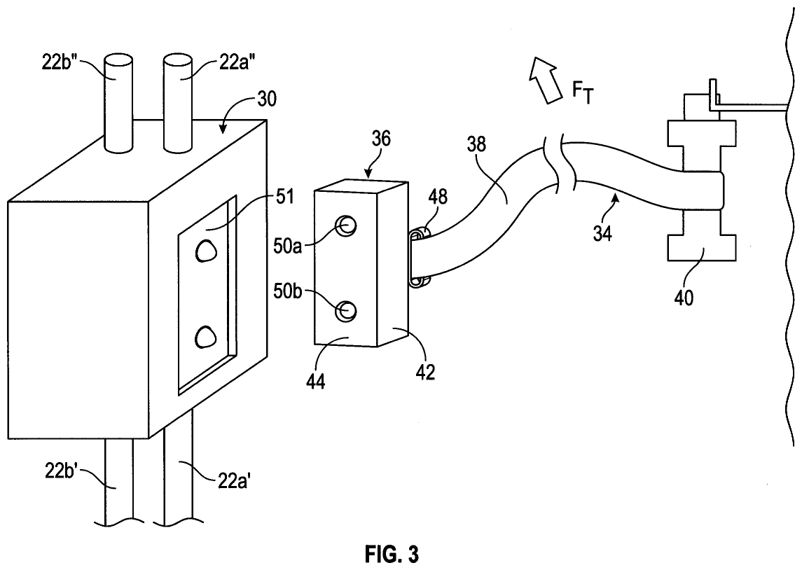

The barrier activator assembly 34 is shown best in FIGS. 2 and 3 as including a magnetic mounting block 36, an elongated flexible barrier strap 38 and a winding spool 40. The magnetic mounting block 36 is shown best in FIG. 3 as including a rectangular plastic block 42 having planar front and rear faces 44, 46, and a pair of rare earth magnets 50a, 50b. The rare earth magnets 50a, 50b are flush mounted within the front face 44. A strap anchor 48 is secured to a mid-portion of the rear face 46. In a simplified construction, the front face 44 is provided as a generally planar surface which is adapted for mated juxtaposed placement with a complimentary formed mounting surface 51 of the valve housing 30.

As shown best in FIG. 1, the barrier strap 38 is adapted to physically cordon off unsafe areas (A_{H}) for the operator 8, with a view to preventing operator entry therein whilst the drilling tool 14 is operated. Preferably, the strap 38 has a longitudinal length which is selected at between about 1 and 10 metres, and most preferably between about 2 and 5 metres. The length of the barrier strap 38 allows it to be positioned in an outstretched orientation, physically impeding access to the area A_{H}. Preferably the barrier strap 38 is secured at its first end to the strap anchor 48 and extends longitudinally therefrom, with the second other strap end coupled to the winding spool 40. The winding spool 40 is selected to allow the barrier strap 38 to be coiled thereabout, and provided with a suitable hook member and/or hangar allowing it to be fixed relative to a mine room wall or pillar (M_{P}). Winding of the barrier strap 38 about the spool 40 allows a desired length of the strap 38 to be secured in an outstretched position under tension, spanning from the drilling tool 14 to the adjacent mine room wall or pillar (M_{P}), as a physical barrier.

FIG. 4 illustrates schematically the valve housing 30 with the mounting block 36 coupled thereto, allowing operation of the drilling tool 14. Each of the fluid flow paths 32a, 32b extend through the valve housing 30 and fluidically communicate the upstream portions 22a′, 22b′ of each respective fluid flow line 22a, 22b which fluidically connect with the control manifold 24, to downstream portions 22a″, 22b″ of the fluid flow lines 22a, 22b which fluidically connect with the motor 18.

The fluid flow paths 32a, 32b further each define a respective valve chamber 52a, 52b, and reverse flow bypass conduit 54a, 54b. As will be described, the reverse flow bypass conduits are each configured to permit a reverse flow of exhaust gas past the associated valve chamber 52a, 52b in an upstream direction.

The valve chambers 52a, 52b, preferably each have the identical construction and are provided in an aligned, side-by-side orientation. As shown best in FIG. 6, each chamber 52 defines a chamber inlet 55 provided in fluid communication with the upstream portions of the associated fluid flow line 22a′, 22b′, a chamber outlet 56 provided in fluid communication with the downstream portions 22a″, 22b″ of the respective flow lines 22a, 22b, and a peripheral extending valve seat 58. The valve seat 58 divides each chamber 52 into an upstream chamber portion 60 and a downstream chamber portion 62. As shown best in FIG. 6, each valve chamber 52 further is provided with a reduced diameter cylindrical bore 64 extending from the mounting surface 51 and opening into the upstream chamber portion 60. Each of the cylindrical bores are configured for substantial alignment with a respective magnet 50a, 50b when the mounting block 34 is moved into juxtaposed placement with the mounting surface 51.

FIG. 6 shows a valve assembly 70 as being associated with each valve chamber 52. Each valve assembly 70 includes a reciprocally movable piston member 72 and a resiliently compressible spring 80. The piston member 72 includes an axially extending, cylindrical ferromagnetic stem 74, which is slidably received in the bore 64 in a substantially fluid-tight arrangement therewith, an enlarged diameter support flange 76, and an elastomeric seal element 78 mounted to a downstream side of the support flange 78. The seal element 78 is sized for selective mated engagement with the valve seat 58.

The helical spring 80 is disposed about the about the valve stem 74, interposed between the piston flange 78 and valve housing 30.

FIGS. 6 and 8 show the ferromagnetic stem 78 as extending from the piston flange 78 into the bore 60. The stem 78 has an axial length selected whereby each piston member 72 is reciprocally movable relative to the valve chamber 52 between a retracted position shown in FIG. 6, and the extended position shown in FIG. 8. In the retracted position the seal element 76 is moved away from engaging contact with the valve seat 58 to compress the spring 80, allowing air flow in the downstream direction from the upstream chamber portion 60 into the downstream chamber portion 62; and the distalmost end of the stem 74 is positioned substantially flush with the mounting surface 51, allowing air flow. In the extended position shown in FIG. 8, the piston member 72 is moved axially under the bias of the spring 80 to re-position the seal element 78 in sealing contact with the valve seat 58, to substantially prevent pneumatic air flow therepast in the downstream direction.

The springs 80 are preferably chosen to provide a resilient biasing force on the piston member 72 which is selected whereby the positioning of the front face 44 of plastic block 42 in juxtaposition with the mounting surface 51 results in the magnetic force attraction between each magnet 50a, 50b and the ferromagnetic stem 74 of each piston member 72, effecting the repositioning and retention of the piston members 72 to the retracted position. Although not essential, more preferably, the magnetic attraction between rare earth magnets 50a, 50b and the ferromagnetic stem 74 of each piston member 72 further is selected to maintain the mounting block 36 in the mounted orientation coupled with the valve housing 30 without friction or mechanical connectors, and which the barrier strap 38 in a tensioned configuration. The magnets 50a, 50b are preferably selected to maintain coupling between the mounting block 36 and valve housing 30 against the application of a minimum threshold force on the barrier strap 38 selected at between about 0.5 N and 25 N, and most preferably between about 1 and 5 N.

Although not essential, FIG. 4 shows best each reverse flow bypass conduit 54a, 54b as being formed within the valve body 30. Each bypass conduit 54a, 54b provides fluidic communication between upstream and downstream portions of each respective fluid flow path 32a, 32b across the associated valve chamber 52a, 52b. The reverse flow bypass conduits 54a, 52b further include a respective one-way check valve 84. The check valve 84 is selected to permit only a reverse flow of pneumatic fluid in the upstream direction, from the rotary motor drive 18 and towards the control manifold 24, as for example during the exhausting of pneumatic fluids.

In use, the mounting block 36 is mounted in juxtaposed contact with the mounting surface to move the piston member 72 in each valve chamber 52a, 52b to the retracted position of FIG. 6. The barrier strap 38 is then extended and secured by the winding spool 40 in an outstretched orientation, as a physical barrier to entry into the hazardous area (AH) adjacent the drilling tool 14. The winding spool 40 may optionally be used to tension the barrier strap 38 to maintain its outstretched orientation with a tension selected less than a threshold tension force necessary to effect detachment of the mounting block 36 from the valve housing 30.

The drilling assembly 12 is operated in drilling operations by the control panel 20 while the user 8 stands behind the outstretched and position barrier strap 38, and at a position remote from the drilling tool 14.

In drilling, the control panel 20, is used to operate the pneumatic control manifold 24 to effect the selective operation of the pneumatic valving 28 to alternatively, direct pneumatic airflow from the pneumatic air supply 15 into the first fluid flow line 22a to rotate the motor drive 18 in a first direction (D₁), and then into the second fluid flow line 22b, to rotate the motor drive 18 in the second opposite direction.

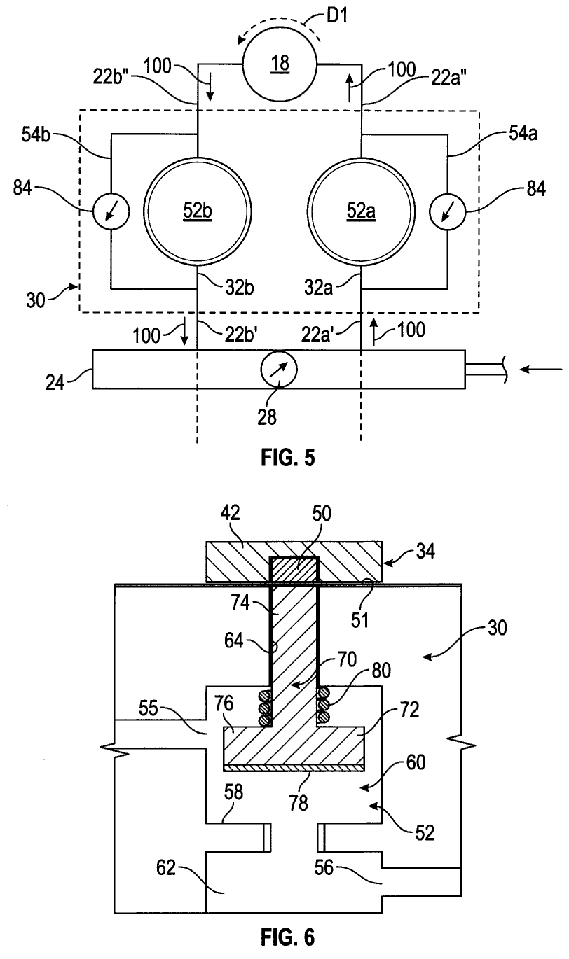

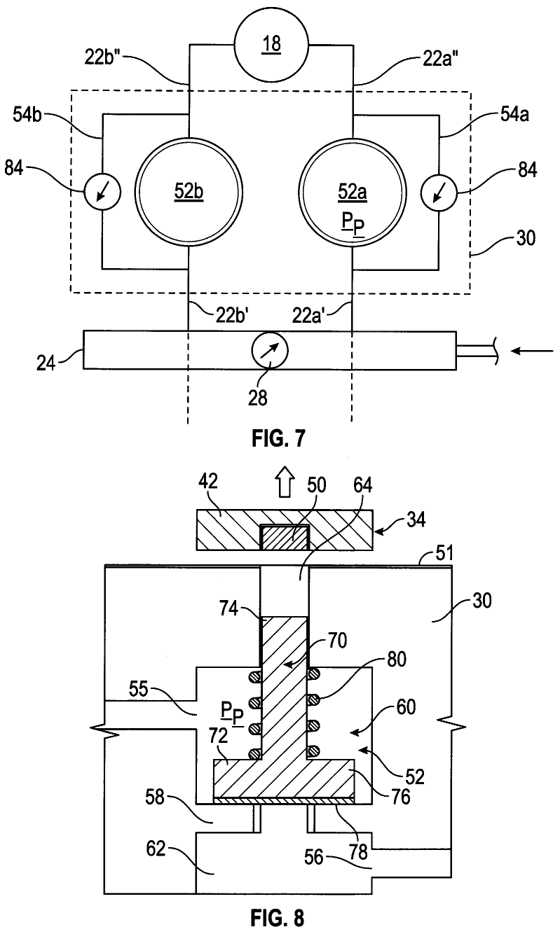

FIG. 5 shows best the movement of driving air through the valve housing 30, as air flow is directed along the first fluid flow line 22a, and to the motor 18 via the fluid flow path 32a. Airflow moving in the direction of arrow 100 passes first through the valve chamber 52a via its inlet 55 and outlet 56 to rotate the motor 18 in the first direction (D₁). From the motor 18, the airflow 100 is exhausted as return airflow therefrom via the fluid flow line 22b. The exhausted airflow moves from the downstream portion 22bⁱⁱ of the flow line 22b into the fluid flow path 32b, passing through the valve housing 30 via the open valve chamber 52b and bypass conduit 54b.

To drive the drill motor drive 18 in the reverse direction, the pneumatic valving 28 is repositioned to re-direct the driving airflow from the air supply 15 into pneumatic fluid flow line 22b in the opposite direction to arrow 100. Such redirection air moves through flow path 32b and through the valve chamber 52b via the chamber inlet 55 and outlet 56, flowing in the opposite direction to arrow 100 to drive the motor 18 in the reverse direction. The reverse airflow exhausted from the motor 18 moves outwardly via the fluid flow path 32a, and through the valve chamber 52a and bypass conduit 52b.

With the present invention, if the user 8 accidentally or intentionally attempts to move past the tensioned barrier strap 38, the application of the predetermined threshold force (F_{T}) thereon effects the decoupling of the mounting block 36 from the mounting surface 51 of the valve housing 30. On the separation of the magnets, 50a, 50b from the ferromagnetic stem 74 of each piston member 72, the piston members 72 move axially under the bias of the compressed springs 80 to the extended position shown in FIG. 8, repositioning each seal element 78 in sealing contact against the associated valve seat 58. So positioned, the piston member 72 prevent the flow of driving air in the downstream direction past the valve seat 58 and from the chamber outlet 56 of the associated valve chamber 52a, 52b. Further, as shown in FIG. 8, with the positioning of each piston member 72 in the extended position, any pressurization (Pₚ) of the upstream portion 62 as a result of the contained supply airflow from the control manifold 24, is preferably selected to prevent the repositioning of the piston member 72 to the retracted position 74 by the magnetic attraction between the rare earth magnet 50a, 50b and associated piston stem. In one possible mode of operation, to allow for the restart of drilling tool operations, the user 8 must necessarily fully depressurize the drill rig 10, thereby preventing accidental restarts. In an alternative arrangement, the bypass conduits 54a, 54b may be provided with suitable valving to allow for pressure release by the operator 8 to enable the recommencement of drilling.

Although the detailed description describes the barrier assembly 34 as including a flexible barrier strap 38, the invention is not so limited. It is to be appreciated that a number of suitable barrier constructions could alternatively be used. These may include without restriction handles, mesh panels, tabs, flexible tethers, as well as other rigid and/or semi-rigid constructions.

Although the detailed description describes the preferred construction as incorporating rare earth magnets 50a, 50b to effect the securement of the mounting block 36 on the mounting surface 57 and/or repositioning of piston members 72 in retracted positions, other constructions, including mechanical and/or electro mechanical connectors and/or actuators could also be used.

Whilst the detailed description describes the cut-off assembly 10 as being used to interrupt the driving flow of pneumatic fluid to a pneumatic drilling tool 14, the invention is not so limited. It is to be appreciated that the power cut-off assembly 16 may be used to interrupt the supply of power for a number of different types of powered apparatus. Such apparatus may include other types of tools and/or heavy equipment which are powered by the flow of hydraulic and/or pneumatic fluid streams.

Although the detailed description describes and illustrates various preferred aspects in accordance with the best mode, the invention is not limited to the specific construction which is described. Many modifications and variations will now occur to person skilled in the art.

We claim:

1. A pneumatic power cut-off assembly for use with a pneumatically operable tool, the cut-off assembly including a valve housing for fluidic connection to a pneumatic air supply of the tool to selectively interrupt a driving flow of air thereto, a releasable actuator provided for selective attachment to and detachment from the valve housing, and barrier element coupled to the releasable actuator,
the valve housing comprising,
a coupling surface for mated engagement with a mating surface of the releasable actuator, an axially extending bore being formed in said coupling surface,
a pneumatic fluid flow path extending at least partially through the housing from an inlet end to an outlet end, and
a valve chamber formed in said housing and having a chamber inlet fluidically communicating with the inlet end, a chamber outlet fluidically communicating with the outlet end, and a valve seat,
a valve assembly comprising a movable piston having a sealing member selectively positionable by the movement of the piston, and a biasing member,
the sealing member disposed in said valve chamber and selectively positionable between a sealing position, where said sealing member engages said valve seat to substantially restrict a flow of air between said chamber inlet to said chamber outlet, and a flow position, where said sealing member is moved away from said valve seat to permit the flow of air from said chamber inlet to said chamber outlet,
the piston including a ferromagnetic stem portion, axially movable relative to said bore between a retracted position, where said end portion is moved outwardly relative to said coupling face and the sealing member is in said flow position, and an extended position, where said end portion is moved inwardly relative to said coupling face and the sealing member is moved to the sealing position,
the biasing member resiliently biasing the piston towards the extended position, wherein,
the releasable actuator includes a magnet, the magnet being selected whereby when the mating surface is provided in mated engagement with the coupling surface, the magnet providing a force of attraction with said stem portion sufficient to axially reposition the piston to the retracted position against the bias of biasing member.

2. The cut-off assembly of claim 1, wherein said magnet comprises a rare earth magnet disposed in said mating surface.

3. The cut-off assembly of claim 1, wherein said barrier element comprises a flexible strap portion having a longitudinal length selected at between about 1 metre and 10 metres, said cut-off assembly further including a tensioner for maintaining the flexible strap portion under tension with a barrier element tension face, said magnet is selected whereby said force of attraction is selected to maintain mated engagement of said mating surface and said coupling surface under the barrier element tension force selected less than a predetermined threshold force.

4. The cut-off assembly of claim 3, wherein said tool comprises a long hole rock drill, said coupling surface and said mating surface each comprising generally planar surface portions configured for mated juxtaposition.

5. The cut-off assembly of claim 4, wherein said sealing member comprises a flexible diaphragm.

6. The safety barrier of claim 1, wherein said sealing member comprises a resiliently flexible double diaphragm, and whereby on movement to said sealing position, a partial pressurization of said valve chamber by the driving flow of air from said inlet end into said chamber inlet prevents return movement of the piston to the retracted position.

7. The cut-off assembly of claim 1, wherein the biasing member comprises a resiliently compressible spring, and
wherein the predetermined threshold force is selected at between about 0.5 and 15 N, and preferably between about 1 to 5 N.

8. The cut-off assembly of claim 1, wherein the barrier element is selected from the group consisting of a tab, a flexible tether, a flexible mesh panel, and a substantially rigid barricade.

9. The cut-off assembly of claim 1, wherein the sealing member comprises a resiliently deformable diaphragm, further wherein the inlet end fluidically communicates with an upstream portion of a supply line for receiving said supply of driving air, and respectively, at each of the inlet and outlet ends, the outlet end fluidically communicates with a downstream portion of said supply line for supplying said driving air to said tool.

10. The cut-off assembly as claimed in claim 9 further comprising a reverse-flow bypass assembly, the bypass assembly configured to permit a reverse flow of air in a direction opposite to the driving flow and including,
a bypass conduit providing direct fluidic communication between the upstream supply line and the downstream supply line, and
a one-way valve selected to permit airflow along said bypass conduit only from said downstream supply line to said upstream supply line.

11. A pneumatic tool cut-off safety assembly for interrupting a flow of pneumatic fluid from a fluid source to a pneumatically driven tool, the cut-off assembly comprising,
a valve housing comprising,
a valve chamber defining a flow path therein extending from a chamber inlet, adapted for fluidic communication with an upstream supply line for receiving the driving flow of pneumatic fluid from said fluid source, to a chamber outlet adapted for fluidic communication with a downstream supply line for providing said driving flow of pneumatic fluid to said pneumatic tool, and a valve seat disposed along said flow path,
a valve assembly comprising,
a piston having a ferromagnetic portion and sealing surface configured for substantially mated engagement with the valve seat, the piston being disposed for movement relative to said valve chamber between a flow position, wherein said sealing surface is spaced from said valve seat to permit a driving flow of pneumatic fluid from said chamber inlet through said chamber outlet and to said tool, and a sealing position, wherein said sealing surface is moved into sealing contact with said valve seat to substantially prevent the flow of said pneumatic fluid therepast,
a biasing member being selected to resiliently bias the piston towards the sealing position, and
an actuator assembly comprising,
a magnet assembly detachably mountable in a coupled position with said valve housing, the magnet assembly including at least one magnet selected whereby when said magnet assembly is in said coupled position, a magnetic force attraction between said at least one magnet and said ferromagnetic portion effects the repositioning of said piston relative to the valve chamber to the flow position against the resilient bias of the biasing member, and
a release member coupled to the magnet assembly and selected to facilitate the decoupling of the magnet assembly from the valve assembly upon the application of a minimum threshold force thereto to effect the return movement of the piston to the sealing position by the bias of the biasing member, the release member being selected from the group consisting of a handle, a strap, a rigid or semi rigid barricade, a flexible barrier, a gripping member, a tab, a mesh panel, and a flexible tether.

12. The cut-off safety assembly as claimed in claim 11, wherein the release member has a longitudinal length selected at between about 0.5 and 7.5 metres, and said minimum threshold force is selected at between about 0.5 and 10 N.

13. The cut-off safety assembly as claimed in claim 12, wherein said valve chamber comprises an upstream portion on a first side of said valve seat spaced toward said chamber inlet, and a downstream portion on a second other side portion of said valve seat spaced towards said chamber outlet, and wherein a movement of the piston to the sealing position, partial pressurization of the upstream portion by the driving flow of pneumatic fluid prevents movement of the piston to the flow position by the magnetic force attraction.

14. The cut-off safety assembly as claimed in claim 11 further comprising a reverse-flow bypass assembly, the bypass assembly configured to permit a reverse flow of air in a direction opposite to the driving flow and including,
a bypass conduit providing direct fluidic communication between the upstream supply line and the downstream supply line, and
a one-way valve selected to permit airflow along said bypass conduit only from said downstream supply line to said upstream supply line.

15. The cut-off safety assembly as claimed in claim 11, wherein said tool comprises a long hole rock drill, wherein said barrier element comprises a flexible strap portion having a longitudinal length selected at between about 1 metre and 10 metres, said cut-off assembly further including a tensioner for maintaining the flexible strap portion under tension with a barrier element tension face, said magnet is selected whereby said force of attraction is selected to maintain mated engagement of said mating surface and said coupling surface under the barrier element tension force selected less than a predetermined threshold force.

16. A pneumatic long hole drill assembly comprising a reciprocally movable pneumatic drilling tool adapted to receive a flow pneumatic fluid from a pneumatic fluid source, and a pneumatic flow cut-off assembly for interrupting the flow of pneumatic fluid between said fluid source to said drilling tool on the occurrence of an unsafe operator condition,
the drilling tool comprising a rotatory drive, a pneumatic fluid flow circuit selected to provide fluidic communication between said rotary tool and said pneumatic fluid source and comprising first and second flow passages, and a pneumatic control manifold for regulating the flow of pneumatic fluid in the pneumatic fluid flow circuit,
the pneumatic control manifold including,
a fluid inlet for fluidically communicating with the pneumatic fluid source,
a first fluid flow outlet fluidically communicating with said first flow passage to provide a first driving flow of pneumatic fluid therealong in a first driving flow direction to effect rotation of said rotary drive in a first direction,
a second fluid flow outlet fluidically communicating with said second flow passage to provide a second driving flow of pneumatic fluid therealong in a second driving flow direction opposite to said first driving flow direction to effect rotation of said rotary drive in a second opposite direction, and
a control valve for selectively directing the flow of pneumatic fluid outwardly from said first flow outlet or said second flow outlet,
the cut-off assembly including,
a valve housing comprising respective valve chambers associated with each of said first and second flow passages, each valve chamber defining a respective flow path therethrough extending from a chamber inlet to a chamber outlet, the chamber inlet and chamber outlet each being in fluidic communication with respective upstream and downstream portions of the associated said first and second flow passage, and a valve seat disposed along said flow path,
a valve assembly comprising,
a piston disposed in an associated one of the valve chambers, each piston having a ferromagnetic portion and sealing element configured for substantially mated engagement with the valve seat, the piston being disposed for movement relative to said associated valve chamber between a flow position, wherein said sealing element is spaced from said valve seat to permit the associated driving flow of pneumatic fluid from said chamber inlet to said chamber outlet, and a sealing position, wherein said sealing element is moved into sealing contact with said valve seat to substantially prevent associated driving the flow of pneumatic fluid therepast,
a spring member associated with each piston and being selected to resiliently bias the piston towards the sealing position, and
an actuator assembly comprising,
a magnet assembly detachably mountable in a coupled position with said valve housing, the magnet assembly including a magnet associated with each piston, each magnet being selected whereby in the absence of the associated driving flow of pneumatic fluid when said magnet assembly is in said coupled position, a magnetic force attraction between each magnet and the ferromagnetic portion of each associated piston effects the repositioning of said piston relative to the associated valve chamber to the flow position against the resilient bias of the spring member, and
a release member coupled to the magnet assembly and selected to facilitate the decoupling of the magnet assembly from the valve assembly upon the application of a minimum threshold force thereto.

17. The assembly as claimed in claim 16, wherein when each said piston is disposed in said flow position, the sealing element of each piston being moved towards an upstream portion of said associated valve chamber, and on detachment of said magnet assembly, the associated driving flow of pneumatic fluid along the first flow passage or second flow passage in the respective first or second driving flow direction, partially pressurizing the upstream portion of associated valve chamber to prevent movement of the associated piston to the flow position by the magnetic force attraction.

18. The assembly as claimed in claim 16, wherein the first flow passage further includes a first reverse flow bypass conduit for providing fluid communication between the upstream portion of the first flow passage and the downstream portion of said first flow passage, a check valve disposed in said first reverse flow bypass conduit, the check valve being selected to permit only a reverse flow of pneumatic fluid from said rotatory drive to said pneumatic control manifold when said second driving flow of pneumatic fluid flow is supplied in said second driving flow direction.

19. The assembly as claimed in claim 18, wherein the second flow passage further includes second reverse flow bypass conduit providing fluid communication between the upstream portion of said second flow passage upstream from the associated valve chamber and a downstream portion of said second flow passage downstream from the associated valve chamber;
a check valve disposed in said second reverse flow bypass conduit, the check valve being selected to permit only a reverse flow of pneumatic fluid from said rotatory drive to said pneumatic control manifold when said pneumatic fluid flow is supplied in said first driving flow direction.

20. The assembly as claimed in claim 16, wherein the release member is selected from the group consisting of a handle, a strap, a rigid or semi rigid barricade, a flexible barrier, a gripping member, a tab, a mesh panel, and a flexible tether.

21. The assembly as claimed in claim 16, wherein the pneumatic tool comprises a long hole drill, and the predetermined threshold force is selected at between about 0.5 and 25 N, and preferably between about 1 and 5 N.
